(19) United States
(12) Patent Application Publication
(10) Pub. No.: US 2018/0304185 A1
(43) Pub. Date: Oct. 25, 2018

(54) PROCESS AND FILTER DEVICE FOR CLEANING FURNACE GAS

(71) Applicant: DANIELI CORUS B.V., Velsen Noord (NL)

(72) Inventors: Wouter Bernd Ewalts, Nieuw Vennep (NL); Pieter Dirk Klut, Castricum (NL)

(21) Appl. No.: 15/770,061

(22) PCT Filed: Oct. 14, 2016
(86) PCT No.: PCT/EP2016/074767

§ 371 Date: Apr. 20, 2018

(30) Foreign Application Priority Data
Oct. 20, 2015 (EP) 15190600.5

(51) Int. Cl. B01D 46/00; B01D 46/02; B01D 46/04; C21B 7/22; C21C 5/40; F23J 15/02

(52) U.S. Cl. CPC B01D 46/0068; B01D 46/023; B01D 46/04; C21B 2100/44; C21C 5/40; F23J 15/025; C21C 2100/02; C21B 7/22

(57) ABSTRACT

Process and device for cleaning furnace gas includes flowing in a main flow direction (A) the furnace gas passes an array of bag filters. Filtered furnace gas having passed the filter bags, is partly returned via one or more nozzles which are moved along downstream ends of the bag filters. Each bag filter is passed at least once by at least one nozzle during a cycle. A nozzle passing a bag filter blows filtered furnace gas in a backflow direction (B) through said bag filter. The backflow direction is opposite to the main flow direction.

### CROSS-REFERENCE TO RELATED APPLICATION

The present application is a national stage filing of International patent application Serial No. PCT/EP2016/074767, filed Oct. 14, 2016, and published as WO 2017/067861 A1 in English which claims priority European patent application Serial No. 15190600.5 that was filed on Oct. 20, 2015.

### TECHNICAL FIELD

The present disclosure relates to a process and a filter device for dry dust removal of furnace gas resulting from metal production processes, in particular steel or iron production processes, such as blast furnace gas or gas produced with electric arc furnaces (EAF), basic oxygen furnaces (BOF) or with direct reduced iron (DRI) processes.

### BACKGROUND

The discussion below is merely provided for general background information and is not intended to be used as an aid in determining the scope of the claimed subject matter. Blast furnace gas typically has a relatively high carbon monoxide content, e.g., about 20-28%, allowing use as a fuel gas in various types of burners. However, the dust content of blast furnace gas leaving the blast furnace is typically about 10-40 g/Nm³, which is too high for use in such burners. To ensure proper and stable functioning of the burners or other equipment using the blast furnace gas the dust content of the blast furnace gas must be lowered substantially. This is usually done with a two-step process. In a first step the larger dust particles are separated in a cyclone. In a second step the smaller particles are separated, usually by means of a scrubber in a wet process. Such a wet process requires significant water consumption and produces sludge and waste water, which require further treatment. The water scrubbing treatment also results in a drop of pressure and temperature of the treated blast furnace gas, which reduces its efficiency as a fuel gas in a downstream gas burner.

To overcome the drawbacks of wet gas cleaning processes it has been proposed to filter the gas by means of filter bags hanging down from a tube sheet, for instance in the article of Zhang Fu-Ming, “Study on Dry Type Bag Filter Cleaning Technology of BF Gas at Large Blast Furnace”, Proceedings of the 5^{th} International Congress on the Science and Technology of Ironmaking, p. 612-616, 2009, Shanghai, China.

Bag filters can be cleaned by a backflow, usually an inert gas, such as nitrogen, as for instance is disclosed in Lanzerstorfer and Xu, “Neue Entwicklungen zur Gichtgasreinigung von Hochofen: ein Überblick”, BH, vol. 195, p. 91-98, 2014. This can be done off-line or on-line. Off-line cleaning interrupts the filtering process. On-line cleaning has the drawback that the nitrogen gas cools and dilutes the blast furnace gas. To minimize this effect, the nitrogen flow must be ejected with short, very strong pulses using a minimum of nitrogen. These pulses should be very strong to create a shockwave opposite to the 2.5 bar main flow. The maximum length of the filter bags that can be cleaned with such on-line backflows is typically about 4 meters.

The same publication also discusses a Japanese filter device of Kokura Steel Works of 1982 that uses a counter flow of cleaned blast furnace gas for cleaning the filter bags. The filters are taken out of the gas flow and cleaned off-line.

It is an object of the present disclosure to provide a dry cleaning process for dust removal from blast furnace gas using bag filters with an on-line backflow with improved cleaning efficiency allowing the use of longer filter bags.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

The object of the present disclosure is achieved with a process for cleaning furnace gas wherein the furnace gas flowing in a main flow direction passes an array of bag filters. Filtered furnace gas having passed the filter bags, is partly returned via one or more nozzles which are moved along downstream ends of the bag filters, wherein each bag filter is passed at least once by at least one nozzle during a cycle. A nozzle passing a bag filter blows filtered furnace gas into a backflow direction through the bag filter, the backflow direction being opposite to the main flow direction.

Using filtered blast furnace gas for an on-line backflow does not cool or dilute the main blast furnace gas flow. Therefore, much larger amounts can be used than would be possible with nitrogen gas, so the pulses can be longer and may be less strong. Since larger amounts of backflow gas can be used per pulse, the filter bags that can be used, can be made much longer.

The returned backflow gas can be separated from the main flow continuously or intermittently, for instance when the differential pressure over the tube sheet is too high. The amount of returned gas may for example be about 0.1 to about 0.5 vol. % of the main gas flow.

In a specific embodiment, the nozzles are arranged in an arm which is movable over the array of bag filters. The array of bag filters can for example comprise a number of concentric circular arrays, making maximum use of the space in the housing of the filter device, which is typically cylindrical in view of the pressurized process conditions. In that case, the arm with the nozzles may for instance be a rotating arm rotating about a central axis that is coaxial with the circular array of bag filters. The respective nozzles are arranged to pass bag filters having corresponding radial positions during rotation of the rotational arm, so each bag filter is passed by at least one nozzle during a cycle.

In top view the filter bags and the openings in the tube sheet may for example be circular or oval. Using oval filter bags helps to make optimum use of space if the filter bags are arranged in concentric circular arrays. Moreover, the time that a passing nozzle will be above a filter bag will be longer if the filter bags are oval with a radially extending short axis and a tangentially extending long axis, so the backflow pulses will be longer.

The pressure in the blast furnace gas flow in the main direction is typically at least 1.5 bar, e.g., at least 2 or at least 2.5 bar. At the nozzles the backflow pressure may for instance be about 0.1-1.2 bar, e.g., 0.5-1.0 bar, e.g., about 0.8 bar higher than the pressure within main gas flow in the main flow direction.

The use of cleaned blast furnace gas makes it possible to use much larger amounts of backflowing gas.

The disclosed process can effectively be carried out with a filter device for cleaning processing gas in a metal production process, comprising at least one vessel with:
a gas inlet at a bottom section;
a gas outlet at a top section;
a tube sheet between the gas inlet and the gas outlet.
   The tube sheet comprises an array of openings, each opening being provided with a filter bag hanging down from said opening. The gas outlet is connected to a discharge line. A return line connects a downstream section of the discharge line with a return inlet at the top end of the vessel. The return line may for example comprise a gas booster to return the clean gas with the desired overpressure. The return line may connect to a rotor with at least one radial arm rotatable about a central axis of the vessel, the rotatable arm defining a channel in communication with the return line, e.g., via a central channel of the rotor positioned coaxially within the vessel. The channel of the radial arm comprises downwardly directed nozzles with radial positions corresponding to radial positions of the openings in the tube sheet, so each bag filter is passed by at least one nozzle during a full cycle of the rotor.

### BRIEF DESCRIPTION OF THE DRAWINGS

The disclosed process and filter device will be further explained with references to the accompanying drawings showing an exemplary embodiment.

FIG. 1: shows schematically a lay out for a filter device for cleaning blast furnace gas;

FIG. 2: shows a rotor with nozzles for cleaning the bag filters of the filter device of FIG. 1;

FIG. 3: shows a detail of the rotor of FIG. 2 in side view.

### DETAILED DESCRIPTION

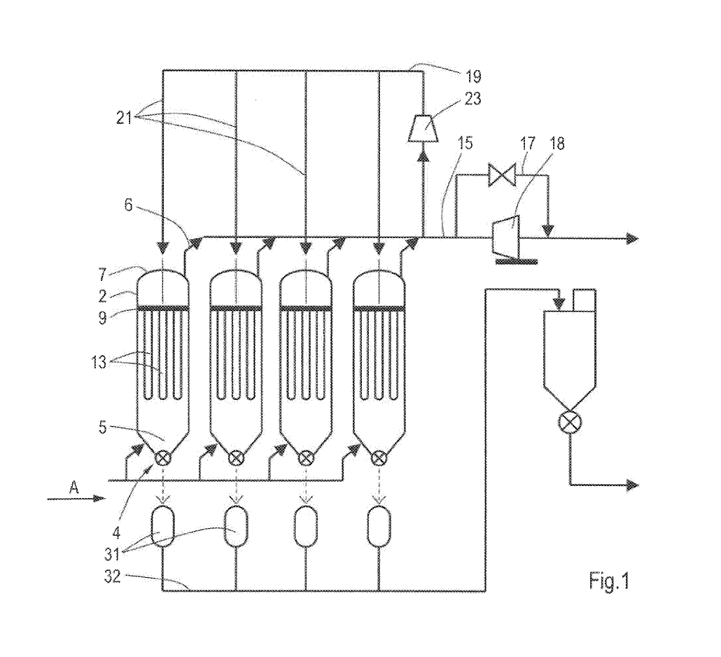

FIG. 1 shows a lay out for a filtering device 1 for filtering blast furnace gas or process gas from similar metal production processes. The gas is supplied from direction A. Optionally, the gas is first treated by means of a dust removal device, such as a cyclone, e.g., for removal of larger dust particles, and/or the gas may first be cooled, e.g., to reduce temperature peaks, and/or treated with absorbents and/or basic agents to remove acidic and organic contaminants.

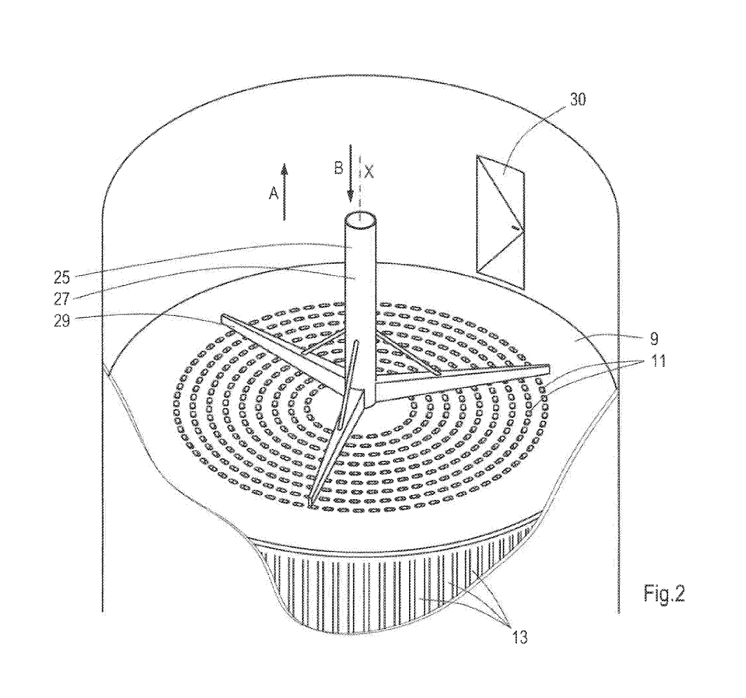

The blast furnace gas is distributed over a number of filter stations 2, in the shown exemplary arrangement four filter stations. Each one of the filter stations 2 comprises a cylindrical pressure vessel with a gas inlet 4 at a bottom section 5 of the vessel 2 and a gas outlet 6 at the top section 7 of the vessel 2. The blast furnace gas flows in a main flow direction A from the bottom section 5 of the vessel 2 to the top section 7. A circular tube sheet 9 is positioned at the top section 7 of the vessel 2. The tube sheet 9 is provided with concentric circular arrays of oval openings 11 (see FIG. 2). The oval openings 11 have short axes in radial direction and long axis extending in tangential direction, relative to the central axis of the tube sheet. A filter bag 13 with a corresponding oval outline in top view hangs down from each opening 11. Each filter bag 13 has an open end connecting to the respective opening 11 in the tube sheet 9, and a closed end 14 at its opposite end. An open frame (not shown) is positioned in each filter bag 13 to keep the filter bag 13 open against the pressure of the main blast furnace gas flow. The peripheral edge of the tube sheet 9 is connected to the inner wall of the vessel 2, so that all of the blast furnace gas is forced to flow via the filter bags 13 in the openings 11.

The outlets 6 of the vessels 2 open into a common discharge line 15 where the filtered gas is discharged via a conventional top gas recovery turbine 17 in order to reduce the pressure by means of expansion. After the pressure reduction the gas can be used as a fuel for burners. A conventional pressure reduction valve 18 may be used as a back-up in case the top gas recovery turbine would not be operational.

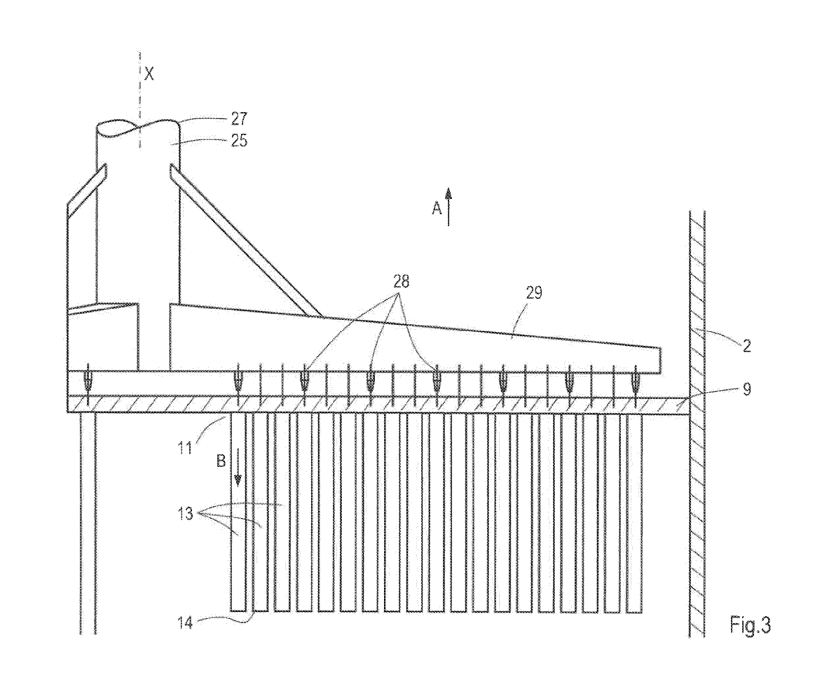

A main return line 19 branches off from the common discharge line 15 and splits into a number of return lines 21, one return line for each one of the vessels 2. The main return line 19 comprises a gas booster 23 increasing the pressure of the return flow to a level above the pressure in the main gas flow. Each return line 21 connects to a rotor 25, shown in more detail in FIGS. 2 and 3. The rotor 25 defines a substantially vertical central channel 27 coaxially positioned within the vessel interior in the space above the tube sheet 9. The rotor 25 is rotatable about a longitudinal axis X of the central channel 27. The rotor 25 comprises a number of radial hollow arms 29 connected to the lower end of the central channel 27. The radial arms 29 define channels with nozzles 28 at their side facing the tube sheet 9. The radius of each circle of openings 11 corresponds to the radial position of at least one of the nozzles 28 of at least one of the radial arms 29. In the shown embodiment, each spacing between two adjacent nozzles 30 of the arm 29 equals three times the distance between an opening 11 in the tube sheet 9 and a next opening 11 in radial direction. As a result only one out of three openings are cleaned by the nozzles 28 of one radial arm 29. The nozzles 28 of the other two arms 29 are arranged in such a way that they clean the remaining filter bags 13. Hence, during each full rotation of the rotor 25 each opening 11 in the tube sheet 9 is passed once by a nozzle 13 of one of the radial arms 29.

A door 30 provides access to the space above the tube sheet 9 for maintenance or repair.

The bottom sections 5 of the respective vessels 2 are conical and collect separated dust. Below the conical sections 5 of the vessels 2 are dust collection bins 31 connecting to a dust discharge line 32.

Raw blast furnace gas is supplied to the vessels 2 and passes the bag filters 13 in a main flow direction A. The pressure in the main flow at the inlet 4 of the vessel 2 is typically about 2.5 bar. Filtered gas is collected in the top sections 7 of the vessels 2, while dust remains at the outer surface of the filter bags 13.

Filtered gas collected downstream the tube sheet 9 is discharged via the respective outlets 6 and the discharge line 15. Part of the gas is continuously withdrawn via the return line 19. The gas booster 23 increases the pressure, e.g., to at least 3.3 bar, 0.8 bar higher than the pressure in the main flow.

Filtered gas flows via the return lines 21 to the top sections 7 of the respective vessels 2, via the central channel 27 and the three radial arms 29 of the rotor 25, where the gas is blown by the nozzles 28 in a backflow direction B which is opposite to the main flow direction A. The nozzles 28 blow the clean gas into the respective tube sheet openings 11 facing the respective nozzles when the nozzles pass by during rotation of the rotor 25. Since the central channel 27 and the radial arms 29 are continuously rotated each opening 11 is passed by a blowing nozzle 28 during a full rotation cycle of the rotor 25.

The gas blows into the openings 11 with an overpressure of, for example, about 0.8 bar. Dust collected on the outer surface of the filter bags 13 is blown away and falls down to the bottom section 5 of the vessel 2. This restores the filter capacity of the bag filter 13.

If sufficient dust is collected at the bottom section 5 of the vessels 2, a dust discharge valve is opened and the dust is collected in the respective collecting bins 31. The dust is further discharged via the dust discharge line 32, e.g., for further treatment.

1. A process for cleaning furnace gas wherein the furnace gas flowing in a main flow direction (A) passes an array of bag filters,
wherein filtered furnace gas having passed the filter bags, is partly returned via one or more nozzles which are moved along downstream ends of the bag filters, wherein each bag filter is passed at least once by at least one nozzle during a cycle,
wherein a nozzle passing a bag filter blows filtered furnace gas in a backflow direction (B) through said bag filter, wherein the backflow direction is opposite to the main flow direction.

2. The process of claim 1, wherein the nozzles are arranged in at least one arm which is movable over the array of bag filters.

3. The process of claim 2, wherein the array of bag filters is a circular array and wherein the arm is a rotating arm rotating about a central axis that is coaxial with the array of bag filters, wherein the respective nozzles are arranged to pass bag filters having corresponding radial positions during rotation of the rotating arm.

4. The process of claim 1, wherein the backflow (B) is blown with 0.1-1.2 bar overpressure relative to the pressure within the furnace gas flow in the main direction (A).

5. The process of claim 1, wherein the pressure in the furnace gas flow in the main flow direction (A) is at least 1.5 bar.

6. A filter device for cleaning processing gas in a steel production process, comprising at least one vessel with:
a gas inlet at an upstream section;
a gas outlet at a downstream section;
a tube sheet between the gas inlet and the gas outlet, the tube sheet comprising an array of openings, each opening being provided with a filter bag;
wherein the gas outlet is connected to a discharge line and wherein a return line connects a downstream part of the discharge line with a return inlet at the downstream section of the vessel.

7. The filter device of claim 6, wherein the return line comprises a gas booster.

8. The filter device of claim 6, wherein the return line connects to a rotor with at least one radial arm rotatable about a central axis of the vessel, wherein the rotatable arm defines a channel communicating with the return line the channel having downwardly directed nozzles at positions corresponding to radial positions of openings in the tube sheet.

9. The filter device of claim 6, wherein the bag filters comprise filter bags with a length of more than 8 meter.

10. The filter device of claim 6, wherein the array of openings in the tube sheet comprises a set of concentric circular arrays of openings.

11. The filter device of claim 10, wherein the openings in the tube sheet are oval with a radially extending short axis and a tangentially extending long axis, relative to the circular arrays of openings.
